(19) United States
(12) Patent Application Publication
(10) Pub. No.: US 2016/0234346 A1
(43) Pub. Date: Aug. 11, 2016

(54) USER REQUEST RESPONSE MANAGEMENT AND MOBILITY

(71) Applicant: Gallery I.P. Telephony Ltd., RaAnana (IL)

(72) Inventor: Avihai DEGANI, Ramot-HaShavim (IL)

(21) Appl. No.: 15/019,989

(22) Filed: Feb. 10, 2016

Related U.S. Application Data
(60) Provisional application No. 62/114,106, filed on Feb. 10, 2015.

(51) Int. Cl. H04L 29/06; G06F 17/30; H04L 29/08

(52) U.S. Cl. CPC H04L 67/42; H04L 67/12; G06F 17/30864; H04L 67/10

(57) ABSTRACT

According to some embodiments of the invention there is provided a method for selecting one or more response values to a user request. The method comprises an action of receiving a user request from a client terminal and collecting one or more sensor values from the client terminal. The method comprises an action of applying automatically one or more selected rules from two or more rules using the user request and the sensor values, wherein the selected rules produces a selection of a target application from two or more applications stored in a remote database. The method comprises an action of running automatically the target application on a remote processor to produce the response values. The method comprises an action of sending response values to the client terminal. The remote database and the remote processor are incorporated in one or more server computers.

### RELATED APPLICATION

This application claims the benefit of priority under 35 USC 119(e) of U.S. Provisional Patent Application No. 62/114,106 filed on Feb. 10, 2015, the contents of which are incorporated herein by reference in their entirety.

### BACKGROUND

The present invention, in some embodiments thereof, relates to user requests and, more specifically, but not exclusively, to responding to a user request based on computerized rules.

Mobile devices, such as smartphones and tablets, have become the personal computing device of choice for most consumers. When a user orders a pizza, the user installs a Pizza Hut application on their mobile device, executed the application, enters their personal information to register the application, and then enter the details for the pizza to be ordered. When a user orders a taxi, the user performs similar steps with a mytaxi application. When a user monitors their home with a smarthome hub, the user installs an internet application to access the status of devices in their home in a similar process. When the user wants to see a movie, the user chooses from multiple movies available through various user subscriptions, such as NetFlix, Hulu, HBO go, and the like, and orders the movie they wish to see from an application, such as a client module that access an application programming interface, through a web page, or by downloading the movie and using a video player application on a client terminal. Optionally, the user orders movie theater tickets from a movie theater web site or a smartphone application. In parallel to the interfaces for receiving products and/or services, there are infrastructure providers that compete to provide multiple products and/or services to millions of users. For example, Time Warner Cable, Verizon, and the like provide access to movies as well as sale of products through affiliated marketing methods. These infrastructure providers make large efforts to attract, engage, and retain a customer's attention by offering competitive advantages and incentives.

For example, in the broadcast media industry there exist multiple station operators, digital content providers, “over-the-top” sources, internet television (ITV) sources, and internet protocol television (IPTV) sources that provide streaming audio and/or video to users. For example, the different providers use different marketing and sales models that grant different media usage rights.

As used herein, the term preferred provider means any provider of a service, an object, a media service, a content service, a content rights reseller and/or a streaming digital media over the internet and/or other high bandwidth interface. As user herein, the term third-party content provider means the system and/or company that owns rights to and/or provides digital media content to a user, different from the preferred provider.

### SUMMARY

According to some embodiments of the invention there is provided a method for selecting one or more response values to a user request. The method comprises an action of receiving a user request from a client terminal. The method comprises an action of collecting one or more sensor values from the client terminal used to generate one or more response values to the user request. The method comprises an action of applying automatically one or more selected rules from two or more rules using the user request and the sensor values, wherein the selected rules produces a selection of a target application from two or more applications stored in a remote database. The method comprises an action of running automatically the target application on a remote processor to produce the response values. The method comprises an action of sending response values to the client terminal. The remote database and the remote processor are incorporated in one or more server computers located remotely to the client terminal and wherein a computer network connects the server computers and the client terminal.

Optionally, the method further comprises an action of receiving automatically a change in sensor values, re-applying the rule according to the change, and re-running the target application according to the change.

Optionally, the response values are one or more members from a group consisting of: streaming video source address, streaming audio source address, an output of the target application, a confirmation message that the user request has been received, and a confirmation message that the user request is being processed.

Optionally, the sensor values are one or more members from a group consisting of: a time and date sensor, a location sensor, a device identification sensor, a gyroscopic sensor, a temperature sensor, a humidity sensor, a motion sensor, a magnetic field sensor, an elapsed time sensor, a video sensor, an audio sensor, a pulse-rate sensor, a proximity sensor, a light-level sensor, carbon monoxide sensor, a smoke alarm sensor, an electromagnetic radiation sensor, a wireless-network sensor, and a cellular-network sensor.

Optionally, the client terminal is one or more members from a group consisting of: a desktop computer, a laptop computer, a tablet computer, a hand-held computer, a telephone computer, a vehicle-integrated computer, and a wearable computer.

Optionally, the user request is a streaming content request, wherein the rule determines a selected content provider from two or more available content providers, based on two or more user subscriptions, and the streaming content request, and wherein the response values are a content server source address from the selected content provider for viewing a streaming content by the user.

Optionally, the method further comprises an action of receiving a second user request to perform a change to a new client terminal for viewing of the streaming content request. The method further comprises an action of modifying automatically the content server source address to conform to the new client terminal, taking into account current playing state of the streaming content, to produce a continuing content server source address. The method further comprises an action of sending automatically the continuing content server source address to the new client terminal, such that the streaming content is perceived uninterruptedly by the user.

Optionally, the continuing content server source address is provided by an alternate content provider, different from the selected content provider.

Optionally, the continuing content server source address is provided by the selected content provider.

Optionally, the user interface allows searching for content on the third party content providers.

Optionally, the continuing content access address is provided to the player device when a change in the player device causes a change in an access right of the selected content.

Optionally, a change of the sensor values are automatically detected and the content server source address is automatically modified to conform to the change, taking into account current playing state of the streaming content, to produce a continuing content server source address.

Optionally, the user request is initiated by an entity from a group comprising a person, a machine, a household appliance, an industrial controller, and a vehicle.

Optionally, the client terminal is operated by the entity.

Optionally, the remote processor is incorporated into an entity from a group comprising a responding client terminal, a machine, a vehicle, an information server, a content server, and a data server.

Optionally, the user request is initiated by any event from a group comprising a time, a response received to a previous user request, a value received from a second sensor, and a condition of one or more household sensors.

Optionally, the user request comprises a preferred target application.

According to some embodiments of the invention there is provided a computer readable medium comprising computer executable instructions adapted to perform the method.

According to some embodiments of the invention there is provided a computerized system for selecting one or more response values to a user request. The computerized system comprises one or more storage mediums for storing two or more rules to apply to a user request received from a client terminal. The computerized system comprises one or more internet interfaces for receiving the received user request from a client terminal, collecting one or more received sensor values from the client terminal, and sending one or more response values to the client terminal. The computerized system comprises one or more processing units comprising two or more processor instructions.

The processor instructions are configured to apply automatically one or more selected rules from the rules, wherein the selected rules produce a selection of a target application from two or more applications stored in a remote database. The processor instructions are configured to run automatically the target application on a remote processor to produce the response values. The processor instructions are configured to send the response values to the client terminal. The remote database and the remote processor are incorporated in one or more server computers located remotely to the computerized server system and the client terminal and wherein the computerized server system, the server computers and the client terminal are connected by a computer network.

Optionally, processor instructions are executed by one or more server modules.

According to some embodiments of the invention there is provided a computer program product for selecting one or more response values to a user request. The computer program product comprises a computer readable storage medium. The computer program product comprises first program instructions to receive a user request from a client terminal. The computer program product comprises second program instructions to collect one or more sensor values used to generate one or more response values to the user request. The computer program product comprises third program instructions to apply automatically one or more selected rules from two or more rules using the user request and the sensor values, wherein the selected rules produce a selection of a target application from two or more applications stored in a remote database. The computer program product comprises fourth program instructions to run automatically the target application on a remote processor to produce the response values. The computer program product comprises fifth program instructions to send the response values to the client terminal. The first, second, third, fourth, and fifth program instructions are stored on the computer readable storage medium, wherein the remote database and the remote processor are incorporated in one or more server computers positioned remotely to the client terminal, and wherein the server computers and the client terminal are connected together on a computer network.

Unless otherwise defined, all technical and/or scientific terms used herein have the same meaning as commonly understood by one of ordinary skill in the art to which the invention pertains. Although methods and materials similar or equivalent to those described herein can be used in the practice or testing of embodiments of the invention, exemplary methods and/or materials are described below. In case of conflict, the patent specification, including definitions, will control. In addition, the materials, methods, and examples are illustrative only and are not intended to be necessarily limiting.

Implementation of the method and/or system of embodiments of the invention may involve performing or completing selected tasks manually, automatically, or a combination thereof. Moreover, according to actual instrumentation and equipment of embodiments of the method and/or system of the invention, several selected tasks could be implemented by hardware, by software or by firmware or by a combination thereof using an operating system.

For example, hardware for performing selected tasks according to embodiments of the invention could be implemented as a chip or a circuit. As software, selected tasks according to embodiments of the invention could be implemented as a plurality of software instructions being executed by a computer using any suitable operating system. In an exemplary embodiment of the invention, one or more tasks according to exemplary embodiments of method and/or system as described herein are performed by a data processor, such as a computing platform for executing a plurality of instructions. Optionally, the data processor includes a volatile memory for storing instructions and/or data and/or a non-volatile storage, for example, a magnetic hard-disk and/or removable media, for storing instructions and/or data. Optionally, a network connection is provided as well. A display and/or a user input device such as a keyboard or mouse are optionally provided as well.

### BRIEF DESCRIPTION OF THE SEVERAL VIEWS OF THE DRAWINGS

Some embodiments of the invention are herein described, by way of example only, with reference to the accompanying drawings. With specific reference now to the drawings in detail, it is stressed that the particulars shown are by way of example and for purposes of illustrative discussion of embodiments of the invention. In this regard, the description taken with the drawings makes apparent to those skilled in the art how embodiments of the invention may be practiced.

In the drawings:

FIG. 1 is a schematic illustration of an system for responding to a user request using a rule and remote application, according to some embodiments of the invention;

FIG. 2 is a flowchart of a method for responding to a user request using a rule and remote application, according to some embodiments of the invention;

FIG. 3 is a schematic illustration of an example content aggregation system to allow content access management and mobility, according to some embodiments of the invention;

FIG. 4 is a flowchart of an example method to manage and change content access using a content aggregation system, according to some embodiments of the invention;

FIG. 5A is a first part of a schematic illustration of an example use case allowing a user to access content, according to some embodiments of the invention;

FIG. 5B is a second part of a schematic illustration of an example use case allowing a user to access content, according to some embodiments of the invention;

FIG. 5C is a third part of a schematic illustration of an example use case to allow a user to access content, according to some embodiments of the invention;

FIG. 5D is a fourth part of a schematic illustration of an example use case allowing a user to access content, according to some embodiments of the invention;

FIG. 6A is a schematic illustration of components of an example system and system components to allow content access management and mobility, according to some embodiments of the invention;

FIG. 6B is a schematic illustration of a conceptual model of an example cloud-based system to allow content access management and mobility, according to some embodiments of the invention; and

FIG. 6C is a schematic illustration of a second conceptual model of an example cloud-based system to allow content access management and mobility, according to some embodiments of the invention.

### DETAILED DESCRIPTION

The present invention, in some embodiments thereof, relates to user requests and, more specifically, but not exclusively, to responding to a user request based on computerized rules.

Many such user request relate to streaming media access and, more specifically, but not exclusively, to uninterrupted streaming media access from content provider sources to user player devices, such as client terminals. Examples from streaming content access are used in this application for in-depth descriptions of responding to a user request according to some embodiments of the invention.

### Technical Problem(s) with Existing Solutions

The complexity of having multiple mobile device applications, multiple service providers, multiple sources of response data, and multiple ways to receive the response causes users much effort in getting a response to their request. For example, the user picks a provider to send a request, and determines how to send the request, such as a web page, a mobile device application, a phone service, and the like. For example, the user decides how to receive the response. As used herein, the term responding entity means the owner of the responding system that produces the response to the user request, and may be a third-party provider different from the preferred provider. Each response entity uses an application, a web site, or a phone service and tries to make their response method attractive and easy to use for the user. None of the responding entities provides a one stop solution to all user requests.

The infrastructure and large content providing networks would like to retain the customer's attention and increase their customer base, thereby increasing their revenues. As used herein, the term preferred provider means the infrastructure or broadcast provider of choice separate from the responding entity, such as a third party provider, that is the source of the response. A preferred provider wishes to respond to most user requests and thus allowing the user needs to interface with the preferred provider most of the time, thereby retaining the user's attention.

For example, the broadcast and/or streaming media industry, matching between the desired content a user wishes to receive, the user's subscription rights to different content providers and contents, and the availability of the content, cause high amounts of user interaction and effort to enable access to the content. This is especially true when the user wishes to play the content at more than one location and at more than one time. For example, a user has Time Warner cable access at home, and HBO go for mobile content access. When during the viewing of movie on television at home and the user is required to leave the home to transport a motor vehicle for servicing, the user searches for a content provider the user has a subscription to, has access to the content, and has access rights for a mobile device outside the user premises before continuing to watch the movie. When found, the user manually connects a mobile device to the secondary content provider, fast forwards the movie to the point they left off, and continues watching the movie while their car is being serviced. When the movie is not available from their regular roaming subscription at the service center, the user has to search for an alternate content provider, establish an account and/or payment method, log in to the alternate provide and then fast forward to where they left off. This process may cause unnecessary anguish to the user to transfer the viewing to the mobile device and view the movie without interruption.

### Solution and Features of Solution that Solve Problem

The present invention, in some embodiments thereof, relates to systems and methods to respond to a user request using a database of rules, a remote database of applications, an application selected based on the rule, request, and collected sensor values, and running this application on a remote processor. A rule is chosen by a response aggregation system from the rule database based on the user request and collecting one or more sensor data values. The rule, request and sensor value(s) determine which application needs to be executed, and initiates execution of this application on a remote processor to receive the response. The response received from the remote processor may be sent by the response aggregation system to the mobile terminal of the user that originated the request. The rules and/or applications may reside on a local and/or remote database.

For example, embodiments of the invention are used to manage access to streaming digital media content between one or more third-party content providers and one or more playing devices of a user. Some embodiments of the invention allow the user to request a content, automatically locating the third-party content provider based on user subscription rights, automatically receive a content streaming address, transfer the streaming address to the player device, and stream the content to the user selected player device continuously, and/or optionally, across multiple devices. In some embodiments of the invention, a content aggregation system and method aggregate the user subscriptions and devices, the user accesses content with a minimum of steps. For example, when during the playing of the content the user wishes to change the location and/or device, the content aggregation system automatically modifies the streaming media address and transfers a content access address to the player device so the user continues receiving the content without interruption. For example, the content aggregation system automatically chooses a new third-party content provider when needed. The term automatically means the associated action is performed without user intervention by a component of the content aggregation system and/or a server connected to the content aggregation system.

As used herein, the term subscriptions means the content and/or service providers the user has paid subscriptions for, such as HBO go, Netflix, Kindle, iTunes, Amazon prime, and the like.

As used herein, the term content access rights means the user access rights to a specific content and/or service, which may depend upon the content, player device location, access time, and content provider.

For example in the content delivery industry, the response aggregation system may comprise a content aggregation system configured as a streaming media manager to coordinate between user subscriptions, content access rights, third-party content providers, the desired player device, and the player device location so the user has access to the media with only a few simple actions. The content aggregation system may include a database of user subscriptions, which may aggregate all available third-party content provider sources available to the user, and store all the access codes to each provider so by a simple initial identification the user has transparent access to all providers. Since many family members may use the same subscriptions, each family member may be defined as their own user with possible different subscriptions, access rights, and mobile devices.

The content aggregation system also aggregates a database of all available content, so the user may choose target media to hear and/or see regardless of the third-party content provider. When restrictions exist on content access rights, such as restrictions in playing time, player location, and or player device, the content aggregation system may notify the user at the time of content selection, and offer mitigating access alternatives. For example, the content aggregation system offers a pay-per-view access to selected content or a change in subscription rights by upgrading a subscription from partial access to full access. The content aggregation system further comprises user interfaces to setup subscriptions, search content, choose player device, and manage player session.

When the user has selected a content and player device, the content aggregation system automatically requests a content access address, and transfers the address to a client module application on the player device so the player device has streaming access to the content. During player sessions, the user may manage the player functions locally using the player device, and the session functions using a web-based user interface. The player device may be a mobile player device or a stationary player device, and the content may be accessed simultaneously by more than one device. For example, the mobile device is a mobile phone, a smart phone, a tablet, a laptop, and the like. For example, the stationary device is a set top box, a television set, a personal computer, and the like.

### Concise Description of Combined Method and Device of Some Embodiments

In the content provider example, the content aggregation system 120B may comprise a content access module for management of multiple content provider subscriptions of a user. The user is required to provide a single authentication action on the content access module to access one or more content provider subscriptions, in addition to all other available content provider sources, such as public domain and/or free content services. The content aggregation system may contain an access rights database for all content available to a user, and allow the user to search for content the user wishes to access. The content aggregation system may aggregate sources for the selected content and may allow the user to select the source of the content, the device to receive the content, and the user's location. Based on this information, the content aggregation system establishes a streaming access connection between the content provider source and an application on the player device, initiating a content access session. When the user requests to transfer the content access session to an alternative player device and/or location the content aggregation system may establish a second streaming access connection between the same or different content provider source and an application on the second player device and/or location. The content aggregation system then continues the content access from the second player device so the playing of the content is uninterrupted.

### Major Options of Some Embodiments

Optionally, the response to the user request is a request for a service, an object, a notification, an access to digital media content, a change to one or more digital storage value, and the like. For example of a service, the user requests a haircut as a service and the response is a service provider arriving at their home to perform the haircut. For example of an object, the user requests a pizza and the response is delivery of a pizza. For example of an access to digital media content, the user requests to listen to a song and the response is streaming content access of the song to the home stereo. For example of an access to digital media content, the user requests to see a movie on an automobile video screen and the response is streaming content access of the movie to the automobile video screen. For example of a change to a digital storage value, the user requests to pay for street parking of a rental car, and the response is the response aggregation system automatically registering the rental car with Pango and initiates payment for the parking using a Pango application running on a remote processor. For example of a change to a digital storage value, the user requests to send a party invitation to friends and family, and the response is open a Whatsapp group for friends and family and share an invitation for the party with the Whatsapp group.

Optionally, a user may send a user request from a client terminal and select the response to be sent by the response aggregation system to a second client terminal.

For example, the user uses his smartphone to send a request to play a Dore the Explorer episode on the children's tablet device. For example, the user uses his smartphone while driving home to send a request to order pizza and popcorn for delivery, such as a response, at home when they arrive.

Optionally, the application run remotely is a mobile device application. For example, the mobile application is run remotely to allow a user to access a mobile application not installed on their client terminal, such as a smartphone with limited storage space.

Optionally, in a content access application the content access session is transferred from one stationary player device to a second stationary player device. For example, a movie is transferred from a television in the living room to a television in the kitchen.

Optionally, in a content access application the content access session is transferred from a stationary player device to a mobile player device. For example, a movie being accessed is transferred from a television in the living room to a tablet player device, and the tablet player device is relocated to the balcony. For example, a movie being accessed is transferred from a television in the living room to a tablet player device, the tablet player device is relocated to a motor vehicle, and the movie playing is continued while the vehicle is moving.

Optionally, in a content access application, the content access session is playing on one player device, and the content aggregation system changes the content provider from a first content provider to a second content provider due to changes in access rights during the playing of the movie. For example, a movie is being played on a tablet at the user residence using access rights from a local cable provider. The tablet is relocated to a neighboring residence with access rights from Netflix™, and the content aggregation system changes from content provider from the local cable provider to Netflix.

Before explaining at least one embodiment of the invention in detail, it is to be understood that the invention is not necessarily limited in its application to the details of construction and the arrangement of the components and/or methods set forth in the following description and/or illustrated in the drawings and/or the Examples. The invention is capable of other embodiments or of being practiced or carried out in various ways.

The present invention may be a system, a method, and/or a computer program product. The computer program product may include a computer readable storage medium (or media) having computer readable program instructions thereon for causing a processor to carry out aspects of the present invention.

The computer readable storage medium can be a tangible device that can retain and store instructions for use by an instruction execution device. The computer readable storage medium may be, for example, but is not limited to, an electronic storage device, a magnetic storage device, an optical storage device, an electromagnetic storage device, a semiconductor storage device, or any suitable combination of the foregoing. A non-exhaustive list of more specific examples of the computer readable storage medium includes the following: a portable computer diskette, a hard disk, a random access memory (RAM), a read-only memory (ROM), an erasable programmable read-only memory (EPROM or Flash memory), a static random access memory (SRAM), a portable compact disc read-only memory (CD-ROM), a digital versatile disk (DVD), a memory stick, a floppy disk, a mechanically encoded device such as punch-cards or raised structures in a groove having instructions recorded thereon, and any suitable combination of the foregoing. A computer readable storage medium, as used herein, is not to be construed as being transitory signals per se, such as radio waves or other freely propagating electromagnetic waves, electromagnetic waves propagating through a waveguide or other transmission media (e.g., light pulses passing through a fiber-optic cable), or electrical signals transmitted through a wire.

Computer readable program instructions described herein can be downloaded to respective computing/processing devices from a computer readable storage medium or to an external computer or external storage device via a network, for example, the Internet, a local area network, a wide area network and/or a wireless network. The network may comprise copper transmission cables, optical transmission fibers, wireless transmission, routers, firewalls, switches, gateway computers and/or edge servers. A network adapter card or network interface in each computing/processing device receives computer readable program instructions from the network and forwards the computer readable program instructions for storage in a computer readable storage medium within the respective computing/processing device.

Computer readable program instructions for carrying out operations of the present invention may be assembler instructions, instruction-set-architecture (ISA) instructions, machine instructions, machine dependent instructions, microcode, firmware instructions, state-setting data, or either source code or object code written in any combination of one or more programming languages, including an object oriented programming language such as Smalltalk, C++ or the like, and conventional procedural programming languages, such as the “C” programming language or similar programming languages. The computer readable program instructions may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider). In some embodiments, electronic circuitry including, for example, programmable logic circuitry, field-programmable gate arrays (FPGA), or programmable logic arrays (PLA) may execute the computer readable program instructions by utilizing state information of the computer readable program instructions to personalize the electronic circuitry, in order to perform aspects of the present invention.

Aspects of the present invention are described herein with reference to flowchart illustrations and/or block diagrams of methods, apparatus (systems), and computer program products according to embodiments of the invention. It will be understood that each block of the flowchart illustrations and/or block diagrams, and combinations of blocks in the flowchart illustrations and/or block diagrams, can be implemented by computer readable program instructions.

These computer readable program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks. These computer readable program instructions may also be stored in a computer readable storage medium that can direct a computer, a programmable data processing apparatus, and/or other devices to function in a particular manner, such that the computer readable storage medium having instructions stored therein comprises an article of manufacture including instructions which implement aspects of the function/act specified in the flowchart and/or block diagram block or blocks.

The computer readable program instructions may also be loaded onto a computer, other programmable data processing apparatus, or other device to cause a series of operational steps to be performed on the computer, other programmable apparatus or other device to produce a computer implemented process, such that the instructions which execute on the computer, other programmable apparatus, or other device implement the functions/acts specified in the flowchart and/or block diagram block or blocks.

The flowchart and block diagrams in the Figures illustrate the architecture, functionality, and operation of possible implementations of systems, methods, and computer program products according to various embodiments of the present invention. In this regard, each block in the flowchart or block diagrams may represent a module, segment, or portion of instructions, which comprises one or more executable instructions for implementing the specified logical function(s). In some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts or carry out combinations of special purpose hardware and computer instructions.

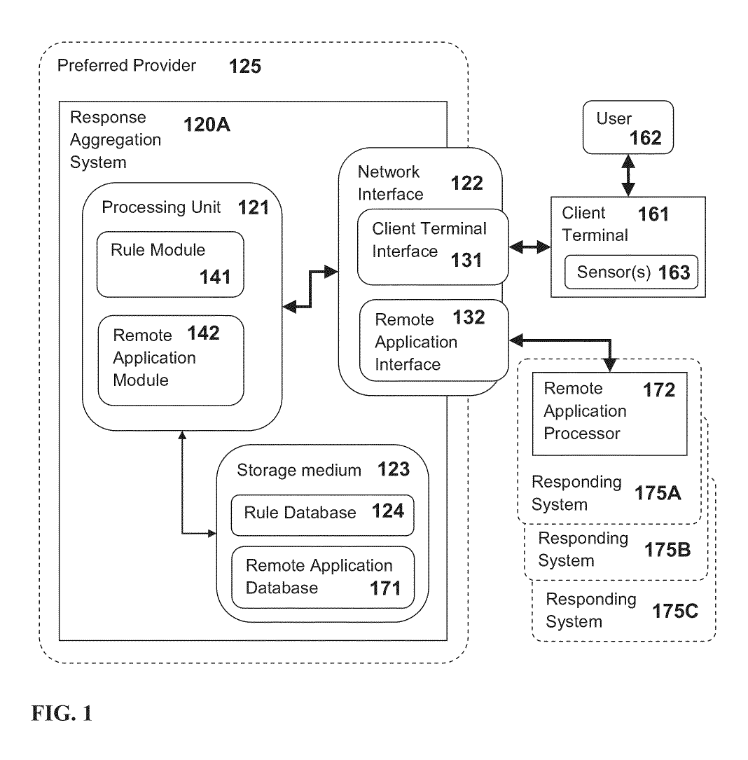

Reference is now made to FIG. 1, which is a schematic illustration of a response aggregation system 120A for responding to a user request using a rule and remote application, according to some embodiments of the invention. The response aggregation system 120A, operated by a preferred provider 125, comprises a processing unit 121, a network interface 122, and a storage medium 123 to respond to the user request. When a user 162 sends a request using a client terminal 161, the request is transferred to the response aggregation system 120A using a client terminal interface 131 part of a general network interface 122. The request is transferred to a processing unit 121 Rule Module 141, which collects one or more sensor 162 values from the client terminal, and selects a rule from the rule database 124 located on a storage medium 123 that applies to the user request and sensor value(s). The rule, user request and sensor values(s) are transferred to the Remote Application Module 142 of the processing unit 121.

The Remote Application Module 142 uses the received information to determine which application of a remote application database 171 is used to respond to the user request, transfers the information and the application to a remote application processor 172 to generate the response, and receives the response from the remote application processor 172. The remote application processor 172 is part of one or more responding systems as at 175A, 175B, or 175C, each of which is associated with a responding entity, such as a third party provider. The Remote Application

Module 142 uses the remote application interface 132 part of the network interface to communicate with the remote application processor 172. The Remote Application Module 142 sends the response to the client terminal 161 for viewing by the user 162, using the client terminal interface 131.

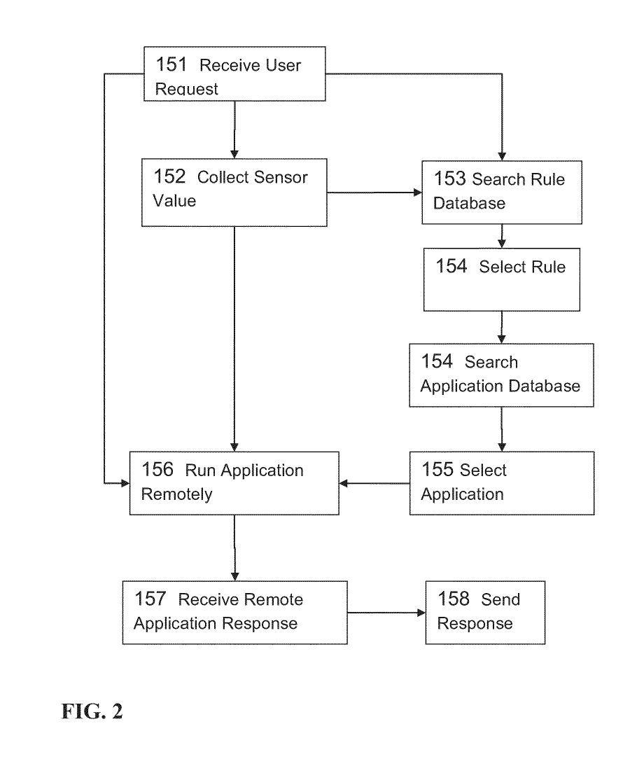

Reference is now made to FIG. 2, which is a flowchart of a method for responding to a user request using a rule and remote application, according to some embodiments of the invention. The method actions are performed by a response aggregation system 120A that receives 151 a user request from a client terminal 161 and when the actions are completed sends 158 the response back to the client terminal. The Rule Module 141 receives the user request and collects 152 one or more sensor values from the client terminal. The user request and sensor value(s) are used by the Rule Module 141 to search 153 a rule database 124 for the rule to apply. The rule, user request, and sensor value(s) are transferred to the Remote Application Module 142 to search 154 for an application to run in a remote application database 171. When an application has been selected 155 by the Remote Application Module 142, the application is run 156 remotely on a remote application processor 172. Optionally, the application is already installed on the remote processor 172. Optionally, the remote processor 172 receives the application from the database 171 and installs the application when it is run for the first time. When the remote application processor completes execution 156 of the application, the Remote Application Module 142 receives 157 the response and sends 158 the response back to the client terminal 161.

For example, when a user wants to order a pizza, the user enters the request “order the usual pizza” in a preferred provider's web page on the client terminal 161. The Rule Module 141 receives 151 the request and collects 152 the global positioning system (GPS) sensor 163 value to determine the nearest pizza provider and the location where the pizza is to be sent. The Rule Module 141 uses the request and location to look up a rule in the rule database 124, such as “when ordering a usual pizza from home, use Pizza Hut™ and order an extra large pizza with olives”, and the Remote Application Module 142 finds the Pizza Hut application programming interface in the remote application database 171. The Pizza Hut application programming interface receives the pizza order and the location, runs the application and on a remote processor 172 to generate a response, such as “pizza ready and delivered in 25 minutes”, which is received by the Remote Application Module 142, and in turn sent 158 to the client terminal 161. In this example, the response further comprises a pizza delivery to the home. When for example, the location is outside of the home, such as at a park, the Remote Application Module 142 determines when the usual responding entity, such as Pizza Hut, is available for delivery at that location, and when not, orders the pizza from an alternative third-party provider. When for example, the user request is “order a pizza” and the location is determined by the collected GPS value as being in a vehicle on the move, the rule may first request details on the user request and send an intermediate response of “where to deliver?” before choosing the pizza provider.

In a further example, a user request to order a taxi, such as “order a taxi to my location”, is received by the Rule Module 141. The Rule Module 141 collects the GPS sensor 163 value location from the client terminal 161 and collects the local time value from the client terminal 161 local time sensor 163. The Rule Module 141 then applies a rule selected from a database of rules to determine a preferred taxi provider for that time and location. The Remote Application Module 142 picks the remote application from the database to run based on the rule, location, and local time, such as a mytaxi application. The Remote Application Module 142 runs the application on a remote processor 172 and receives a response, such as “taxi will arrive for pickup in 5 minutes”. The Remote Application Module 142 sends the response to the client terminal 161 to notify the user of the taxi pickup response.

In a further example, a user request to check whether the air conditioning is operating after they left their home, such as “did I forget the air conditioning on?”, is received by the Rule Module 141. The Rule Module 141 collects a sensor value 163, such as a memory value, for the internet protocol address of the smarthome hub connected to the air conditioning unit. The Remote Application Module 142 picks the remote application for accessing the smarthome hub from the database to run on the remote processor, and transfers the internet protocol address and remote application to the remote processor, together with the user request to check the status of that air conditioning. Once the application has completed execution on the remote processor, the response, such as the status of the air conditioning unit, is sent to the user terminal.

Optionally, the user request is a request from any entity of the group comprising a person, such as a user, a vehicle, a machine, and the like. For example, the user request is form a person using a client terminal, such as a mobile device, a tablet, a laptop computer, a desktop computer, a smart television, a smart home appliance, and the like. For example, the requesting entity is a vehicle using a client terminal such as a vehicle communication component, a GPS system, and the like. For example, the requesting entity is a machine, such as a supervisory control and data acquisitions (SCADA) system and the client terminal is a network interface.

Optionally, the responding entity is any entity of the group comprising a person, a vehicle, a machine, an information server, a content server, a data server, and the like. For example, the responding entity is a person providing a service in response to a user request for service. For example, the responding entity is a vehicle, such as a smart vehicle and the response is the location of the vehicle. For example, the responding entity is a machine, such as a component of a SCADA system, a smart home appliance, and the response is one or more data values. For example, the responding entity is an information server and the response is an information value. For example, the responding entity is a content server and the response is a streaming content address. For example, the responding entity is a data server and the response is a dataset.

Optionally, the user request is initiated automatically by an event, such as a time, a response to a previous request, a condition of a sensor, and the like. For example, the user request is sent when a time value reaches an alarm time value. For example, the user request is sent according to a schedule. For example, the user request is sent in response to a condition of sensors in a smart home. For example, the new user request is sent when a response to a previous user request is received.

Optionally, the rule selection depends on the type of user request.

Optionally, the user request is a request for service and the rule selection depends on the type of service.

Optionally, the user request comprises a preferred responding entity.

Optionally, the rule selection depends on agreements with businesses, enterprises, government institutions, data/content providers, universities, educational institutions, local government institutions, municipal institutions, and the like.

Optionally, the rule selection depends on laws and regulations applying to the request and/or response.

Following is a description of the benefits of embodiments of the invention. For example, the preferred provider may use embodiments of the invention to respond to most user requests and keep the user's attention within the framework of the preferred provider's web page. This gives the preferred provider the benefit of customer retention by being able to respond to most requests and revenues from affiliated marketing. The user receives the benefits of consistent use and fell of the interface as well as the user benefit of the response aggregation system 120A learning the rule by experience from responses to previous user requests.

Additionally, the user does not have to manage multiple third-party providers, web pages, applications, and the like. For example, the third-party provider application is a web page interface, an application programming interface (API) 132, a client application installed on a remote processor 172, a JavaScript application, and the like. For example, a client application does not need to be installed on the client terminal 161 and is run by the response aggregation system 120A on the remote processor 172. For example, the user request response is received 157, by the response aggregation system 120A, from a third-party response provider using an API interface 132 to the remote processor 172 running 156 the application.

Following is an expanded example of some embodiments of the invention applied to the content provider industry, where a user request is to access a specific content on a client terminal 161, such as a playing device, television, tablet, mobile device, and the like, and the response is a streaming of the content to the playing device. When the user 162 changes the playing device 161 and/or the location of a playing device, the content aggregation system 120B automatically adjusts the remote application running 156 on the remote processor 172 to continue streaming the content so that the user 162 perceives the content without interruption.

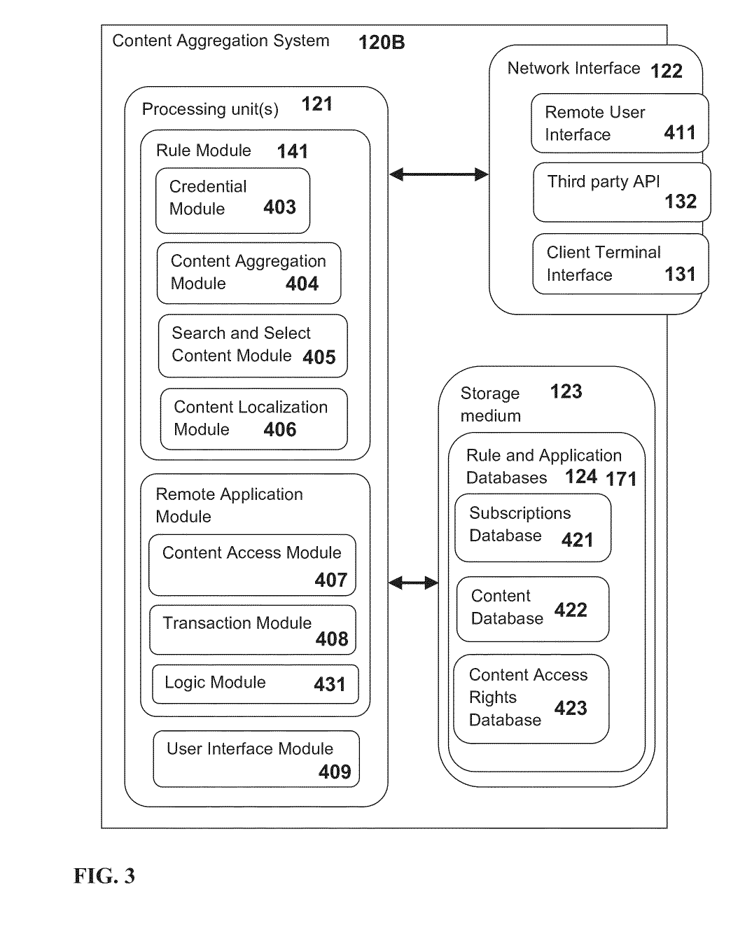

According to some embodiments of the present invention, there are provided content aggregation systems 120B, computerized devices, and client terminal 161 modules to manage access and mobility of content from multiple third-party content providers. As used herein, the term server means a content aggregation system 120B, a virtualized content server, an internet cloud server, and the like. Reference is now made to FIG. 3, which is a schematic illustration of an example content aggregation system 120B to allow content access management and mobility, according to some embodiments of the invention. A content access system 120 may comprise one or more processing units 121, one or more internet interfaces 122, and one or more storage mediums 123. The processing units 121 may comprise modules of processor instructions and/or functions for implementing methods according to some embodiments of the invention, where the processor instructions and/or functions are arranged conceptually among the modules to clarify the embodiment operation.

For example in a content access embodiment, the Rule Module 141 may be configured as a Credential Module 403, a Content Aggregation Module 404, a Search and Select Content Module 405, a Content Localization Module 406, and the like, which together perform the functions of the Rule Module 141 as well as extra functions needed for content access. For example, A Credential Module 403 may determine user credential and subscription rules, allowing the user to access multiple third-party content providers with a single credential logon action. A Content Aggregation Module 404 may aggregate the content access rights for all user subscriptions and public access content. For example, a Search and Select Content Module 405 receives 151 a user request to search for a desired content to access and select the desired content, including features such as content recommendation and marketing. A Content Localization Module 406 may determine the content location and/or provider where a selected content is optimally accessed by searching 153 for the optimum rule in a rules database 124. For example in a content access embodiment, the Remote Application Module 142 may be configured as a Content Access Module 407, a Transaction Module 408, a Logic Module 431, and the like, which together perform the functions of the Remote Application Module 142 as well as extra functions needed for content access.

For example, a Content Access Module 407 receives 157 a content access address from a remote processor 172 and send 158 this address to a selected player device and/or client terminal 161. For example, a Transaction Module 408 monitors the content access and update the content access address when needed, optionally retrieving a new content access address. For example, a Logic Module 431 provides user access logic, user interface logic, user rights logic, provider business logic, and the like, to guide user experience and use cases. Optionally, a User Interface (UI) Module 409 manages all information exchanges with a user, such as receiving a user request, sending a response, login UI, search UI, select UI, change access UI, setup user UI, setup subscriptions UI, user experience (UX), branding, interface skins, interface look and/or feel, and the like.

A storage medium 123 attached locally to a system server, or remotely using distributed storage interfaces, may include user subscriptions database 421, content databases 422, and access rights databases 423, together comprising the rules database 124 and remote application database 171. An internet interface 122 may comprise a remote user interface 411 for user access to system functions, an application programming interface (API) 132 for system access to third-party content providers, a client module interface 131 for sending content access to a player device, a client terminal 161, and the like.

The content access system 120 may comprise a Content Access Module 407 to receive 157 an address for content access from the remote processor 172 and send this to a client module of a client terminal 161 that accesses the content for playing. Optionally, a content aggregation system 120B may comprise modules for user interfaces, user subscriptions, content access rights, content search, content selection, media source localization, media connection, content access transaction management, and the like. Optionally, several processor modules are combined into one or more modules. For example, content search and content selection is incorporated into a Rule Module 141. For example, the system 120 is described as a content and service enabling platform that are the front end between subscribers' devices, system modules, and third-party content provider sources, and include such modules as a Service and/or Content Selection Module, a Media Source Localization Module, Media Connection Manager Module, and the like.

When the system 120 receives 151 a user request of a content identification to access, the Rule Module 141 automatically selects a third-party content provider and utilizes specific application programming interfaces to access the content. The Remote Application Module 142 divert the subscriber's request to the selected third-party content provider and/or service provider by running 156 an application on a remote processor 172, receive 157 the content source address from the remote processor 172, and send 158 the content source address to the client module of the player device. The client module allows the player device to play the content, by receiving the address and establish a steaming connection between the content source and the player program on the device.

Upon receiving a user selection for content to access, the Rule Module 141 may find the optimal third-party provider from the available providers based on the rules in the rule database 124, such as the user's subscriptions, and collected 152 sensor 162 values, such as location, time for access, and device for playing the content. The Remote Application Module 142 may set up access to the content and/or service between a third-party content provider to the selected playing device, and the playing device and/or client terminal 161 begins accessing the content and/or service. When a user wishes to change location, device, time of access, or any other parameter affecting content source address, access rights, and/or selected third-party provider, they method may automatically change the service address, send to the continuing player device, and resume the access to the content from the point last accessed previously.

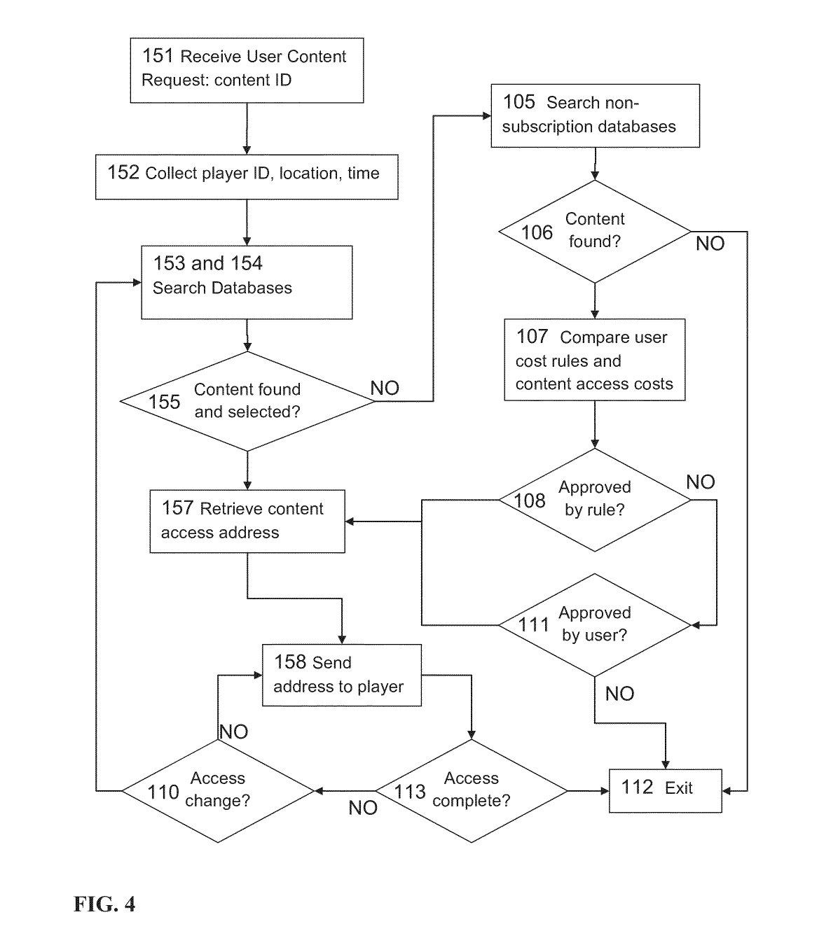

Reference is now made to FIG. 4, which is a flowchart of an example method to manage and change content access using a content aggregation system 120B, according to some embodiments of the invention. A Rule Module 141 receives 151 from a user a content access request, such as the content identification, and collects the player identification, player location, and optionally the time a user wishes to access the content from the relevant sensors 162. The Remote Application Module 142 may search 153 and 154 the user's subscription and access rights databases 423 to find a third-party content provider to access the selected content. When the Remote Application Module 142 finds the third-party content provider 155 with the current user subscriptions, the content access address is received 157 from the third-party content provider and sent 158 to the selected player device by running 156 a third-party content provider application on a remote processor 172. While the user is accessing the content, the system 120 may automatically, periodically and/or intermittently check the sensor values 113. When the access rights have changed 110, such as by a user initiated request, a change in location, a rights change by the third-party content provider, and the like, the Rule Module 141 and the Remote Application Module 142 automatically search 153 and 154 the databases 421 and 423 again to find 155 a third-party content provider, retrieve 157 a new content access address and send 158 the new address to the player device. The Remote Application Module 142 stores the playing position of the content, such that the content is accessed uninterruptedly as perceived by the user.

When the content is not found 155 in any of the user subscriptions, the Rule Module 141 may automatically search non-subscription databases 105, and when the content is found on the non-subscription databases determine when the cost per use is preapproved by an existing user rule 107. When the content access is automatically approved by a rule 108, such as a user rule allowing content access for costs below a certain value threshold, and the content access costs below a predefined threshold, the Remote Application Module 142 proceeds with retrieving a new content access address 157 as described herein. When the existing user rules do not allow automatic content access, the user may be prompted by the Rule Module 141 to approve payment for content access 111, and when approved by the user the Remote Application Module 142 proceeds as herein to retrieve the new content access address 157. When the content access has been completed or the user does not approve the access cost, the content access session is terminated and control exits 112 back to the content selection interface.

As used herein, the term uninterrupted means that the content is accessed continuously without interruption. For example, when the user transfers the content access form a first player device to a second player device, the Remote Application Module 142 automatically stores the time point of the content being played on the first device and the Rule Module 141 determines a continuing third-party content provider for the second player device. The Remote Application Module 142 receives a new content access address, sends the new content access address to the second player device, and instructs the second player device to being playing the content from the time point previously stored.

Following are benefits of some embodiments of the invention. In the examples herein, the user receives the benefits of being able to perform complex tasks easily from a familiar interface. For example, the user does not need to install Pango on their mobile device, learn how to use it, and operate the application to pay for parking of a rental car. In this example, the preferred provider arranges for the rental car, thereby knows the vehicle registration number, and initiates the payment for parking automatically using the Pango application running on a remote server or using an API interface to the Pango server. In the examples herein, the preferred provider operating the system for responding to a user request enjoys the benefit of keeping the user engaged at their web site or client terminal application while offering third party responses to the user request.

For example, following are discussed the benefits of some embodiments of the invention in the content aggregation example described herein. The multiplicity and the variety of third-party content providers complicate a subscriber's choice of selecting a content provider. On the one hand, the subscriber wishes to access the most content and services. On the other hand, none of the existing third-party content providers offers all content, therefore subscribers may have to select one provider and be unhappy with their choice or buy two or more subscriptions in order to cover all their needs. Paying more money for multiple subscriptions may lead to some subscriber dissatisfaction. In addition, the subscriber may need to keep several usernames and password, one of each per subscription.

The choice of third-party content providers is further complicated with different content access rights from different providers, based on the content, location, time and device the user wants to access the content from. Thus a user may be required to begin access to a specific content through one third-party provider at home on the television, and to continue the access from a tablet in the car they must log on to a new content provider from the tablet, find the desired content, access the content, and fast forward the content to where they left off. When the third-party content provider does not have the appropriate rights to this specific content, the user may have to log on to additional content providers, until the user finds the provider with rights to the content they are looking for, given the location, time and device.

According to some embodiments of the present invention, there are provided methods and devices to enable access to any content, regardless of the third-party content provider, at anytime, on any device using a single sign-on. Such embodiments enable a preferred provider, such as a service provider of choice, to achieve marketing and business advantages over their competition. For example, some embodiments of the invention allow a preferred provider to achieve improved subscriber stickiness, engage viewer experience, deliver greater value to customers, increase monetization, and lower subscriber total cost of ownership relative to any other preferred provider.

Optionally, a preferred provider becomes the provider of choice for their customers, utilizing a transparent user experience for any content from any third party source.

Optionally, a preferred provider supports “anywhere, anytime” based the preferred provider's content rights agreements and consumer's subscriptions to third- party content providers.

Optionally, a preferred provider utilizes branding, user interface and/or user experience when accessing third party content, integrating with existing third party systems and components via application programming interfaces.

Optionally, a preferred provider uses a content aggregation system 120B to implement method of content aggregation and mobility across different content player devices and/or locations.

Optionally, a content aggregator system 120B uses a client module such that method logic determined by a Logic Module 431 updated on the system 120 affects the method logic at the client terminal.

Optionally, a preferred provider offers content and services to connect consumer devices to third party content owners and distributors.

Optionally, a preferred provider supports multiple users per device and multiple devices per user.

Optionally, a preferred provider enables a single UI and/or UX to access any content from any source.

Optionally, a preferred provider allows advanced services such as intelligent content search, discovery algorithms, and/or recommendations for third party content.

Optionally, a preferred provider gathers users viewing habits and statistics regardless of content source.

Optionally, a preferred provider retains users by automatically switching user back to preferred provider UI when access to third party content is completed.

Some embodiments of the methods provided herein, enable users to simultaneously execute several mechanisms, authorize access to service and content such as linear broadcast television services, video on demand services and internet content from the system user interface. A user may provide a single sign-on credential to access content from one or more third-party content providers.

Optionally, a user uses one user interface to access content from multiple third-party providers.

Optionally, a user dynamically manages content access rights based on location, time, player device, and the like.

Optionally, a user transfers content access from one device to another seamlessly and without interruption, from one third-party provider to another, one location to another, and the like.

Optionally, the methods of some embodiments are transparent to a subscriber using a central, internet-based content access system.

Optionally, a user stores the credentials to one or more subscriptions they own with third-party content providers.

Optionally, a user uses a single preferred provider credential to access all services for themselves and all other members of their household.

Optionally, each member of a household has unique user credentials to access selective content, store user preferences, manage lists of preferred content, connect with social groups, and the like. The account owner acting as an administrator may grant other members of the household, such as users, options to access content and services with their own user credentials under parental and cost control.

Optionally, a user stores their preferences, graphic user interface (GUI) look and feel, GUI skins and/or styles, and the like on the system.

Optionally, a user personalizes one or more devices and one or more users per device, each being combination or user and device customized to a user's preferences.

Optionally, a user accesses any content in unified, consistent, and/or transparent access to either preferred provider entitled and/or other third party content.

Optionally, a user assigns group and/or social access to content. A user may assign a mixture of viewing groups based on content, location, and/or device.

Optionally, a user operates the service as virtual video on demand (VOD) device. For example, a user operates the content access with VOD features such as a catch-up, start-over, stop and/or resume for live television broadcast, electronic program guides, interactive program guides, and the like.

Optionally, a user transfers the content access between player devices, locations, and users without interrupting the playing of the content.

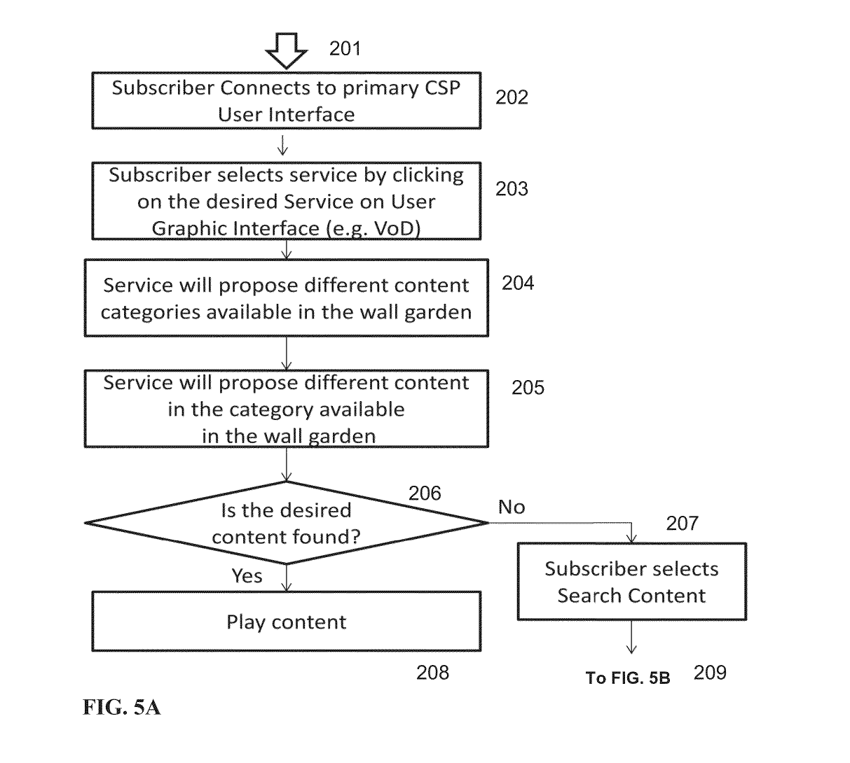

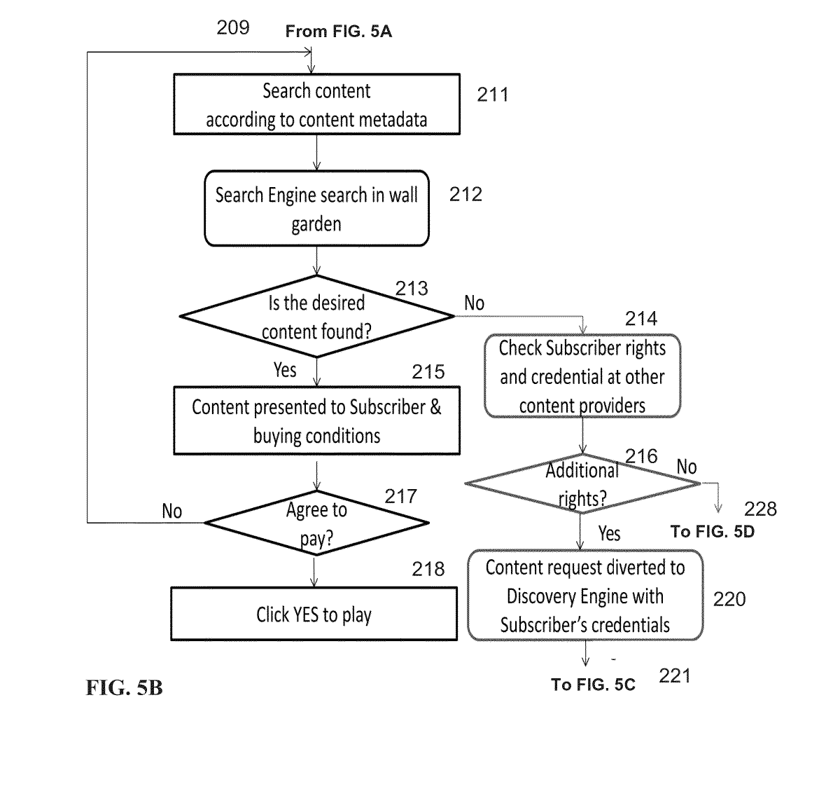

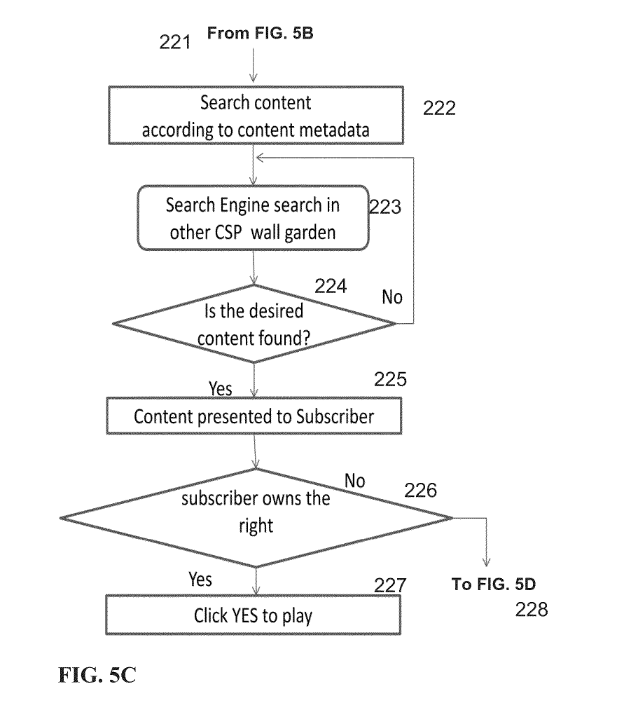

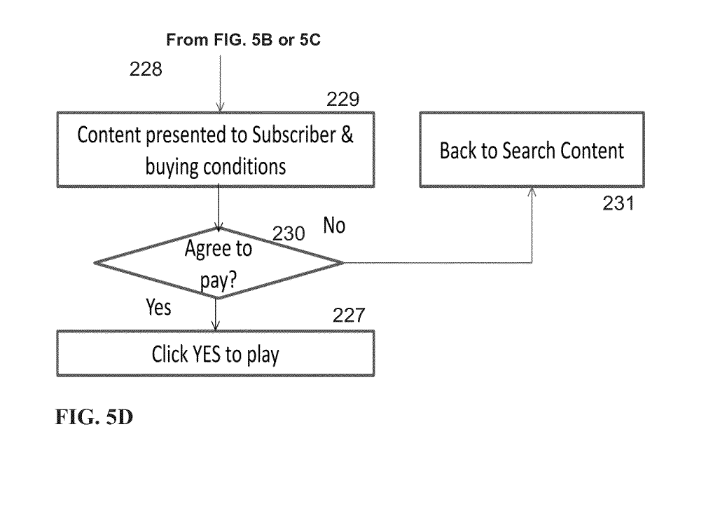

The following section illustrates a detailed example of an instance of content access by a user, such as a subscriber to a preferred provider's services. Reference is now made to FIG. 5A, FIG. 5B, FIG. 5C and FIG. 5D, which are parts of a schematic illustration of an example use case allowing a user to access content, according to some embodiments of the invention. Upon initial connection 201, a subscriber connects to a primary content service provider (CSP) user interface 202 using their single logon credentials. Subscriber selects a desired service 203 and the service proposes content categories 204. Upon selection of a category, the Rule Module 141 of the system 120 proposes different content in the category 205, and when the selected content is found 206, the Remote Application Module 142 prepares the content access to be played on the selected device 208. When the content is not found within the subscriber's current subscriptions, the subscriber may select to search the content from other providers 207, and the flowchart proceeds to the flowchart of FIG. 5B as at 209.

The content is searched for by the Rule Module 141 according to metadata 211 in an ecosystem of content rights, such as a “walled garden” 212, and when the content is found 213, the buying conditions may be presented to the subscriber 215. When the subscriber agrees to pay 217 the content is played via operation of the Remote Application Module 142 on the selected device 218, and when not agrees to pay, a new search is initiated. When the desired content is not found, the subscriber's rights are checked at other content providers 214. When additional rights exist 216 the content request is diverted to a discovery module 219 and on to the flowchart of FIG. 5C. When the additional rights are not available 216, the example use case continues to the flowchart of FIG. 5D.

When continuing from FIG. 5B as at 221, the example use case searches for content according to content metadata 222. A search engine searches within the ecosystem, such as a “walled garden” 223, until the desired content is found 224. When the content is found, the content is presented to the subscriber 225. When the subscriber owns the content rights 226, the content is played 227 on the selected player device. When the content rights are not owned by the subscriber the flowchart of the example use case continues with FIG. 5D as at 228.

The flowchart continues 228 with content buying conditions presented to subscriber 229, and when subscriber agrees to pay 230, content is played 227 on the selected player device. When subscriber does not agree to pay 230, the user is returned to the content search screen 231.

A user interface module 409 may allow a content aggregation system 120B to send and receive information from user. For example, the user interface module 409 receives 151 a user logon, subscriptions, content search, content selection, location, player device, access change instruction, and the like. A credential module 403 may receive a single user credential, which allows the Rule Module 141 to determine automatically the user subscriptions, content access rights, and/or service access rights using a rule database 124 of user subscriptions and/or service rights.

A content aggregation system 120B, such as a content access system, may comprise network architecture of processor modules and databases, such as a logic module, a subscription management module, a third-party content provider database, a search and recommendation management module, aggregation of content databases, a content selection module, a continuous access management module, and the like. A content aggregation system 120B may comprise a client module on the player device to receive a content source address and enable streaming of the content to the player device.

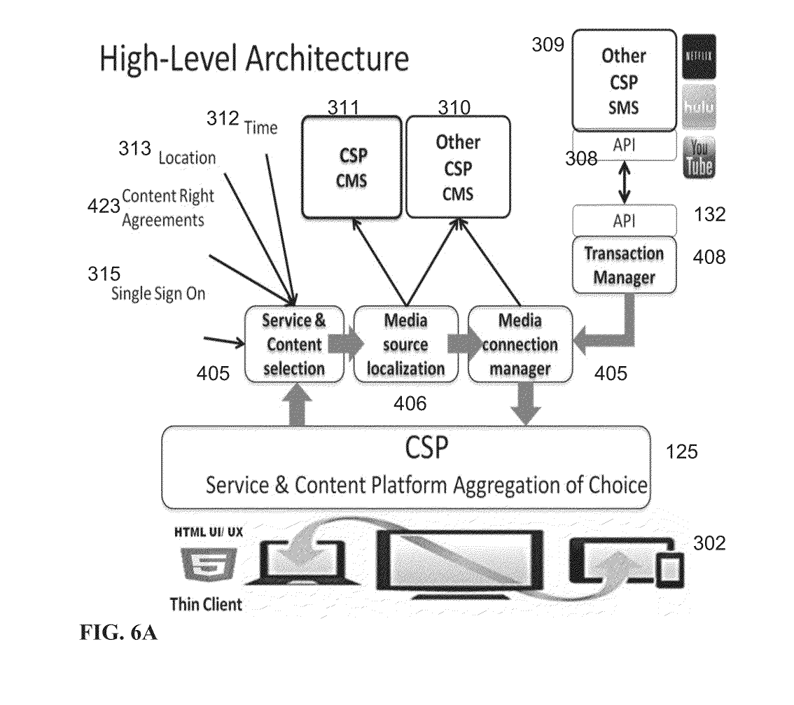

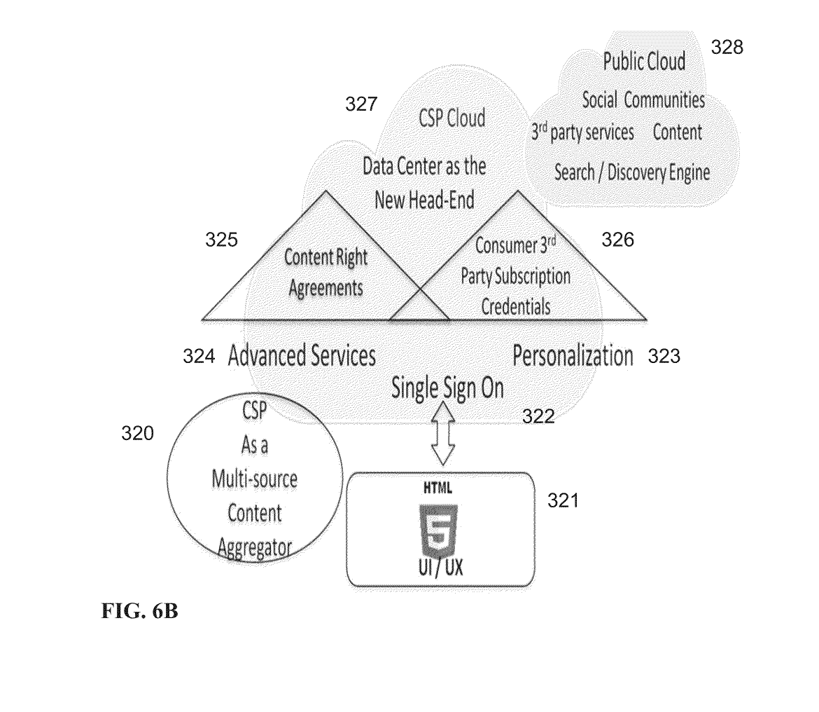

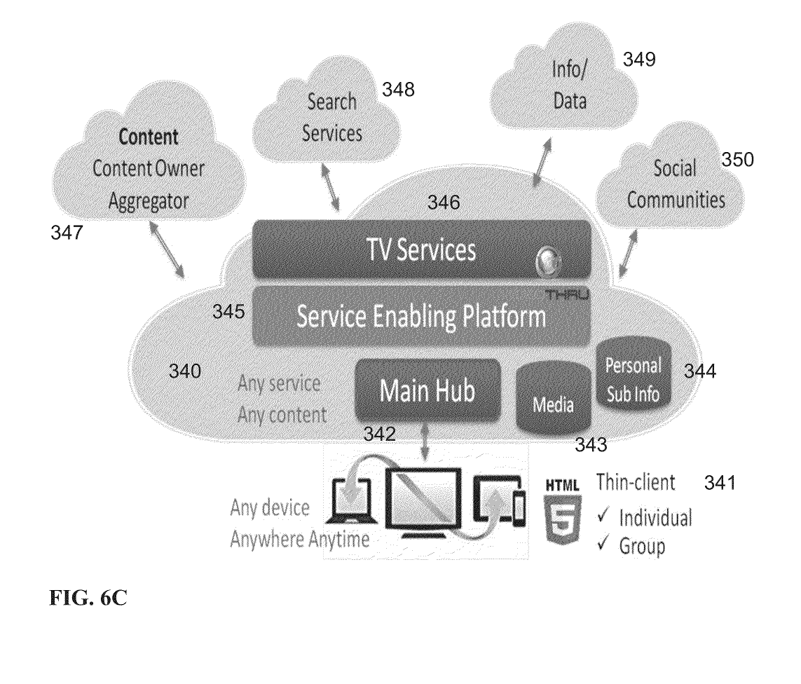

Following are several examples of conceptual system architectures according to some embodiments of the inventions used for content access management and mobility. Reference is now made to FIG. 6A, which is a schematic illustration of an example system 120 and system components to allow content access management and mobility, according to some embodiments of the invention. A network architecture model may be centered on a preferred provider 125, such as a provider of choice, which is the primary access point for all content by a user terminal 141, such as a player device, and may be accessed using a html browser and/or client module 302. Optionally, the content aggregation system 120B is accessed using a separate user interface module 409. The network architecture may include a separate logic module 431. The service and content selection module 405 may be the input point for a single sign on 315, the content rights agreements database 423, content access location 313, and content access time 312. The sensor 162 data collected 152 by the Rule Module 141 may determine the client terminal location 313 and time 312.

The media localization module 406 may access content from both preferred provider content 311 and third party content 310. The service and content selection module 405, media localization module 406, and media connection module 407 may allow content access. When a third-party content provider and content to access is determined by the Rule Module 141, the transaction manager module 408 may use an API interface 307 to access the third-party API libraries 308 to provide the third party content 309.

Reference is now made to FIG. 6B, which is a schematic illustration of a conceptual model of an example cloud-based system 120 to allow content access management and mobility, according to some embodiments of the invention. A content aggregation system 120B may provide an ecosystem for the user as a “content provider of choice” cloud 327. The user access may be controlled through a user interface and user experience over an internet interface to a client browser and/or client module 321. The content provider of choice cloud 327 may include advanced services 324 such as electronic program guide (EPG). The content provider of choice cloud 327 may include a single sign on 322 and personalization features 323. The content provider of choice cloud 327, which may act as a new head end for the content access, incorporates the content access rights 325 and third party subscription credentials of the user 326. Through APIs and other programming access, the content provider of choice cloud 327 may other content and services 328, such as public content, social communities, third party content and/or services, external search and/or discovery engines, and the like.

Optionally, other configurations of network architecture and/or virtualized cloud structures are possible.

Reference is now made to FIG. 6C, which is a schematic illustration of a second conceptual model of an example cloud-based system 120 to allow content access management and mobility, according to some embodiments of the invention. A virtualized server 340, such as a cloud server, may provide content aggregation features to a client browser and/or module 341. The main hub module 342 may interface with the client browser and/or module 341. The main hub module 342 may have access to local media 343 and third party content 347. The main hub module 342 may have access to a user's personal subscription database 344. The main hub module 342 may operate as a service and/or content enabling platform 345, including television services 346. The main hub module 342 may provide access to search services 348, information and/or data services 349, and social communities 350.

Optionally, the system comprises a client module, such as an application running on a player device to receive from the system an internet address for content access to the selected content.

Optionally, the internet address for content access is transferred directly to the media player application running on the player device.

Optionally, a content access system comprises a subscription database module, user database module, an access rights database, a content database, a steaming access module, and the like.

The methods as described above are used in the fabrication of integrated circuit chips.

The flowchart and block diagrams in the Figures illustrate the architecture, functionality, and operation of possible implementations of systems, methods and computer program products according to various embodiments of the present invention. In this regard, each block in the flowchart or block diagrams may represent a module, segment, or portion of code, which comprises one or more executable instructions for implementing the specified logical function(s). It should also be noted that, in some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts, or combinations of special purpose hardware and computer instructions.

The descriptions of the various embodiments of the present invention have been presented for purposes of illustration, but are not intended to be exhaustive or limited to the embodiments disclosed. Many modifications and variations will be apparent to those of ordinary skill in the art without departing from the scope and spirit of the described embodiments. The terminology used herein was chosen to best explain the principles of the embodiments, the practical application or technical improvement over technologies found in the marketplace, or to enable others of ordinary skill in the art to understand the embodiments disclosed herein.

It is expected that during the life of a patent maturing from this application many relevant streaming protocols will be developed and the scope of the term content access, stream and/or internet is intended to include all such new technologies a priori.

It is expected that during the life of a patent maturing from this application many relevant player devices will be developed and the scope of the term player device, client module and/or client browser is intended to include all such new technologies a priori.

It is expected that during the life of a patent maturing from this application many relevant content types will be developed and the scope of the term content is intended to include all such new technologies a priori.

It is expected that during the life of a patent maturing from this application many relevant user interfaces and/or experiences will be developed and the scope of the term user interface and/or experience is intended to include all such new technologies a priori.

It is expected that during the life of a patent maturing from this application many relevant cloud servers and/or servers will be developed and the scope of the term cloud and/or server is intended to include all such new technologies a priori.

As used herein the term “about” refers to ±10%.

The terms “comprises”, “comprising”, “includes”, “including”, “having” and their conjugates mean “including but not limited to”. This term encompasses the terms “consisting of” and “consisting essentially of”.

The phrase “consisting essentially of” means that the composition or method may include additional ingredients and/or steps, but only if the additional ingredients and/or steps do not materially alter the basic and novel characteristics of the claimed composition or method.

As used herein, the singular form “a”, “an” and “the” include plural references unless the context clearly dictates otherwise. For example, the term “a compound” or “at least one compound” may include a plurality of compounds, including mixtures thereof.

The word “exemplary” is used herein to mean “serving as an example, instance or illustration”. Any embodiment described as “exemplary” is not necessarily to be construed as preferred or advantageous over other embodiments and/or to exclude the incorporation of features from other embodiments.

The word “optionally” is used herein to mean “is provided in some embodiments and not provided in other embodiments”. Any particular embodiment of the invention may include a plurality of “optional” features unless such features conflict.

Throughout this application, various embodiments of this invention may be presented in a range format. It should be understood that the description in range format is merely for convenience and brevity and should not be construed as an inflexible limitation on the scope of the invention. Accordingly, the description of a range should be considered to have specifically disclosed all the possible subranges as well as individual numerical values within that range. For example, description of a range such as from 1 to 6 should be considered to have specifically disclosed subranges such as from 1 to 3, from 1 to 4, from 1 to 5, from 2 to 4, from 2 to 6, from 3 to 6 etc., as well as individual numbers within that range, for example, 1, 2, 3, 4, 5, and 6. This applies regardless of the breadth of the range.

Whenever a numerical range is indicated herein, it is meant to include any cited numeral (fractional or integral) within the indicated range. The phrases “ranging/ranges between” a first indicate number and a second indicate number and “ranging/ranges from” a first indicate number “to” a second indicate number are used herein interchangeably and are meant to include the first and second indicated numbers and all the fractional and integral numerals therebetween.

It is appreciated that certain features of the invention, which are, for clarity, described in the context of separate embodiments, may also be provided in combination in a single embodiment. Conversely, various features of the invention, which are, for brevity, described in the context of a single embodiment, may also be provided separately or in any suitable subcombination or as suitable in any other described embodiment of the invention. Certain features described in the context of various embodiments are not to be considered essential features of those embodiments, unless the embodiment is inoperative without those elements.

Although the invention has been described in conjunction with specific embodiments thereof, it is evident that many alternatives, modifications and variations will be apparent to those skilled in the art. Accordingly, it is intended to embrace all such alternatives, modifications and variations that fall within the spirit and broad scope of the appended claims.

All publications, patents and patent applications mentioned in this specification are herein incorporated in their entirety by reference into the specification, to the same extent as if each individual publication, patent or patent application was specifically and individually indicated to be incorporated herein by reference. In addition, citation or identification of any reference in this application shall not be construed as an admission that such reference is available as prior art to the present invention. To the extent that section headings are used, they should not be construed as necessarily limiting.

What is claimed is:

1. A method for selecting at least one response value to a user request comprising:
receiving a user request from a client terminal;
collecting at least one sensor value from said client terminal used to generate at least one response value to said user request;
applying automatically at least one selected rule from a plurality of rules using said user request and said at least one sensor value, wherein said at least one selected rule produces a selection of a target application from a plurality of applications stored in a remote database;
running automatically said target application on a remote processor to produce said at least one response value; and
sending said at least one response value to said client terminal;
wherein said remote database and said remote processor are incorporated in at least one server computer located remotely to said client terminal and wherein a computer network connects said at least one server computer and said client terminal.

2. The method of claim 1, further comprising receiving automatically a change in said at least one sensor value, re-applying said rule according to said change, and re-running said target application according to said change.

3. The method of claim 1, wherein said at least one response value is at least one member from a group consisting of: streaming video source address, streaming audio source address, an output of said target application, a confirmation message that said user request has been received, and a confirmation message that said user request is being processed.

4. The method of claim 1, wherein said at least one sensor value is at least one member from a group consisting of: a time and date sensor, a location sensor, a device identification sensor, a gyroscopic sensor, a temperature sensor, a humidity sensor, a motion sensor, a magnetic field sensor, an elapsed time sensor, a video sensor, an audio sensor, a pulse-rate sensor, a proximity sensor, a light-level sensor, carbon monoxide sensor, a smoke alarm sensor, an electromagnetic radiation sensor, a wireless-network sensor, and a cellular-network sensor.

5. The method of claim 1, wherein said client terminal is at least one member from a group consisting of: a desktop computer, a laptop computer, a tablet computer, a hand-held computer, a telephone computer, a vehicle-integrated computer, and a wearable computer.

6. The method of claim 1, wherein said user request is a streaming content request, wherein said rule determines a selected content provider from a plurality of available content providers, based on a plurality of user subscriptions, and said streaming content request, and wherein said at least one response value is a content server source address from said selected content provider for viewing a streaming content by said user.

7. The method of claim 6, further comprising:
receiving a second user request to perform a change to a new client terminal for viewing of said streaming content request;
modifying automatically said content server source address to conform to said new client terminal, taking into account current playing state of said streaming content, to produce a continuing content server source address; and
sending automatically said continuing content server source address to said new client terminal, such that said streaming content is perceived uninterruptedly by said user.

8. The method of claim 7, wherein said continuing content server source address is provided by an alternate content provider, different from said selected content provider.

9. The method of claim 7, wherein said continuing content server source address is provided by said selected content provider.

10. The computerized server system of claim 9, wherein said user interface allows searching for content on said at least one third party content provider.

11. The computerized server system of claim 9, wherein said continuing content access address is provided to said player device when a change in said player device causes a change in an access right of said selected content.

12. The method of claim 6, wherein a change of said at least one sensor value is automatically detected and said content server source address is automatically modified to conform to said change, taking into account current playing state of said streaming content, to produce a continuing content server source address.

13. The method of claim 1, wherein said user request is initiated by an entity from a group comprising a person, a machine, a household appliance, an industrial controller, and a vehicle.

14. The method of claim 13, wherein said client terminal is operated by said entity.

15. The method of claim 1, wherein said remote processor is incorporated into an entity from a group comprising a responding client terminal, a machine, a vehicle, an information server, a content server, and a data server.

16. The method of claim 1, wherein said user request is initiated by any event from a group comprising a time, a response received to a previous user request, a value received from a second sensor, and a condition of at least one household sensors.

17. The method of claim 1, wherein said user request comprises a preferred target application.

18. A computer readable medium comprising computer executable instructions adapted to perform the method of claim 1.

19. A computerized system for selecting at least one response value to a user request comprising:
at least one storage medium for storing a plurality of rules to apply to a user request received from a client terminal;
at least one internet interface for receiving said received user request from a client terminal, collecting at least one received sensor value from said client terminal, and sending at least one response value to said client terminal;
at least one processing unit comprising a plurality of processor instructions adapted to:
apply automatically at least one selected rule from said plurality of rules, wherein said at least one selected rule produces a selection of a target application from a plurality of applications stored in a remote database;
run automatically said target application on a remote processor to produce said at least one response value; and
send said at least one response value to said client terminal;
wherein said remote database and said remote processor are incorporated in at least one server computer located remotely to said computerized server system and said client terminal and wherein said computerized server system, said at least one server computer and said client terminal are connected by a computer network.

20. The computerized server system of claim 19, wherein said plurality of processor instructions are executed by at least one server module.

21. A computer program product for selecting at least one response value to a user request, comprising:
a computer readable storage medium;
first program instructions to receive a user request from a client terminal;
second program instructions to collect at least one sensor value used to generate at least one response value to said user request;
third program instructions to apply automatically at least one selected rule from a plurality of rules using said user request and said at least one sensor value, wherein said at least one selected rule produces a selection of a target application from a plurality of applications stored in a remote database;
fourth program instructions to run automatically said target application on a remote processor to produce said at least one response value; and
fifth program instructions to send said at least one response value to said client terminal;
wherein said first, second, third, fourth, and fifth program instructions are stored on said computer readable storage medium, wherein said remote database and said remote processor are incorporated in at least one server computer positioned remotely to said client terminal, and wherein said at least one server computer and said client terminal are connected together on a computer network.
